(19) United States
(12) Patent Application Publication
(10) Pub. No.: US 2011/0307168 A1
(43) Pub. Date: Dec. 15, 2011

(54) Weather-sensitive route mapping

(76) Inventor: Ryan Kieff, Camp Hill, PA (US)

(21) Appl. No.: 13/067,592

(22) Filed: Jun. 13, 2011

Related U.S. Application Data
(60) Provisional application No. 61/344,222, filed on Jun. 14, 2010.

(51) Int. Cl. G01C 21/00

(52) U.S. Cl. 701/200

(57) ABSTRACT

A wireless phone navigation system that obtains and uses weather system data to alert and re-route a user around inclement weather located at a point on the user's navigated route, as predicted to be at a time in the future that the user would otherwise be expected to traverse that part of the navigated route. A weather polygon is drawn around a perimeter of a weather system obtained from current weather data. The weather polygon (or other shape) may be drawn based on configurable weather items to be avoided, e.g., rain, ice conditions, snow on ground, etc. The re-routing may be based on a prediction of a future position of a weather system with respect to where on a navigated route a user will be at that future time.

The present application claims priority from U.S. Provisional No. 61/344,222 entitled “WEATHER-SENSITIVE ROUTE MAPPING SYSTEM”, filed Jun. 14, 2010, the entirety of which is explicitly incorporated herein by reference.

### BACKGROUND OF THE INVENTION

1. Field of the Invention

This invention relates generally to wireless communication. In particular, it relates to GPS-based navigation services that provide turn-by-turn directions on a wireless device.

2. Background of Related Art

Turn-by-turn navigation on wireless phone devices such as wireless smartphones is known. However, the present inventor has appreciated that unforeseen events may occur along the future route. For instance, wireless phone navigation used by travelers such as bicyclists, motorcyclists, etc., may unexpectedly direct them into a travel route through a location of an unknown current or future traffic accident.

FIG. 2 shows a conventionally-navigated route from location A to location B, wherein a weather system crosses the route.

Conventionally, when a traveler comes upon traffic congestion, wireless phone navigation systems permit a user to manually request re-routing for a given distance ahead on routed route to avoid an upcoming accident or other traffic congestion. Such a typical conventional device permits a user to select a fixed distance ahead to re-route, e.g., 1 mile ahead, 2 miles ahead, etc. In response to the manual input, the conventional wireless phone navigation device re-routes that distance of the previously-generated route.

### SUMMARY OF THE INVENTION

In accordance with the principles of the present invention, a method of providing to a wireless navigation device navigation which avoids a weather system, comprises obtaining current weather data relating to travel to a given destination. A polygon shape is defined around a perimeter of a weather system in the current weather data to form a weather polygon. A location of the weather polygon is established, and a trip is routed to the given destination which minimizes travers of the weather polygon.

### BRIEF DESCRIPTION OF THE DRAWINGS

Features and advantages of the present invention will become apparent to those skilled in the art from the following description with reference to the drawings, in which:

FIG. 1 depicts how a route is altered as by an impending weather system along a navigated route, in accordance with the principles of the present invention.

FIG. 2 shows a conventionally-navigated route from location A to location B, wherein a weather system crosses the route.

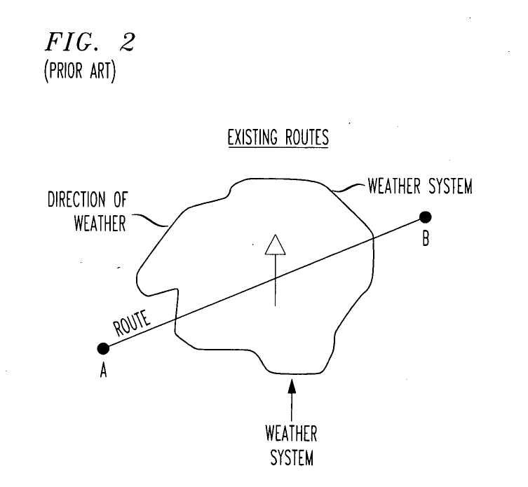

### DETAILED DESCRIPTION OF ILLUSTRATIVE EMBODIMENTS

The present inventor has appreciated that future weather affects a navigated route to be traveled, much like a traffic accident or the like, even though the weather has not yet crossed onto a portion of the path to be traveled. Using conventional techniques, a traveler must rely on a weather forecast before taking off on a trip to decide if, when and what roads to travel. When making such a decision, the traveler must become somewhat clairvoyant, particularly on longer trips, as weather patterns move over time and may or may not affect a point in the trip when the traveler reaches that point.

At best, conventional navigation systems require a user to select a desired fixed distance ahead on the route to have re-routed as a detour route. However, such conventional systems require the traveler to decide on their own how to detour around a weather system, e.g., a motorcyclist coming upon a sudden rain storm), or a traveler alerted to possible thunderstorms in the area for the next 4 hours, etc. The present inventors have appreciated that neither situation is ideal.

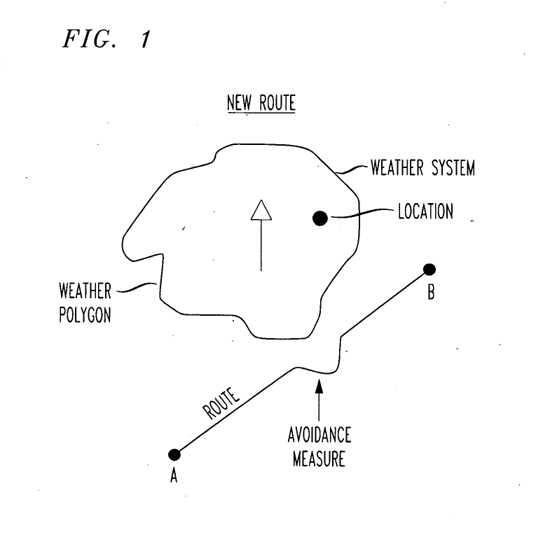

FIG. 1 depicts how a route is altered as by an impending weather system along a navigated route, in accordance with the principles of the present invention.

The present invention provides a wireless phone navigation system that obtains and uses weather system data to alert and re-route a user around inclement weather located at a point on the user's navigated route, as predicted to be at a time in the future that the user would otherwise be expected to traverse that part of the navigated route. The re-routing may be based on a prediction of a future position of a weather system with respect to where on a navigated route a user will be at that future time.

The present invention obtains and uses the size, speed and direction of a storm system on a 2-dimensional map (such as a Doppler radar map) to construct a polygon around the adverse system, thus permitting positioning assignment of the weather system.

The weather system may be, e.g., radar data acquired from a weather forcast service such as weather.com, the National Weather Service, etc.

The polygon is a simple perimeter drawn around the perimeter of a weather system. The polygon may alternatively be a circle (or other basic shape) overlaid around an area on a map with the midpoint of the polygon or shape being a theoretical middle of the weather system. From that midpoint, a radius is drawn to the farthest point at which precipitation is measured from the midpoint to determine the outer edge of the system.

The polygon shape may be any shape having a perimeter. However, for the purposes of simple modeling, a circle is used. A multisided “fence” (e.g., ellipsoids or multi-sided polygons) is also possible. The modeled weather polygon is given a position corresponding to its midpoint. Once the midpoint (latitude & longitude) is acquired from the circle (or other shape or polygon) is drawn around the radar data (map), the coordinates of the weather system are calculated via coordinate linear algebra on the midpoint and radius, as well as the distance=speed*time equation, to calculate the weather system's path.

Once the position of a defined weather shape is obtained, its future movement and forecast is included to influence the calculation of driving directions, including providing automatic re-routing or detouring around a future intersection between a moving weather system polygon and a routed route. Thus, in accordance with the principles of the present invention, a weather system influences the calculation of driving directions so that the user will avoid the defined weather system polygon.

The severity of a weather system around which to draw a polygon (or other shape) is preferably configurable by the user, though a default condition is preferred. For instance, a motorcyclist might be most concerned about actual rain, and thus they would prefer that a weather system polygon be drawn around rain elements in radar data. On the other hand, a driver of a vehicle might be less concerned about mere rain, and thus not desire to be routed around a rain storm, but instead might desire to avoid icy conditions (e.g., rain and temperature below 38 degrees, etc.), to avoid snow on ground, etc.

As the polygon (weather system) actually moves across a 2-dimensional map, actual navigation is re-routed accordingly. Preferably, actual navigation is re-routed based on accurate predictions of the intersection between future weather along a future point reached on a routed route. Also, preferably, as a prediction of movement of a given weather system either become more accurate or becomes based on more recent information, the navigation system preferably re-routes a route to avoid the most recent, best weather predictions. The re-routing preferably attempts to route the user around the entire weather polygon as that is most likely the best chance at an “all clear” route to travel.

The defined center or position of the weather polygon may preferably be weighted toward an area within said weather polygon which contains more severe weather than a remaining portion of said weather polygon. Thus, if the most severe, or if most density, of a given weather system is toward an edge of a weather polygon, the location of the weather polygon is biased toward said higher storm density.

Preferably, the re-routing or detouring around an intersection of the weather polygon and a route to be traveled counters the direction that the weather polygon is currently traveling in. For instance, if the weather system (and thus the weather polygon) is moving North, the adjusted re-routing around the weather polygon preferably navigates South of the southern edge of the weather polygon if reasonably possible, or if otherwise desired by the user.

The principles of the present invention can be implemented to alert a traveler to advise them to either continue to travel on a routed route, or even to seek shelter in the case of an immediately impending severe weather system.

The present invention has applicability to users that dislike driving in the rain or other bad weather (including bicyclists, motorcyclists, automobiles, hikers, outdoorspeople, etc.) It also enhances road safety and helps to avoid or prevent unnecessary weather related accidents. The invention also allows vulnerable travelers (e.g., bicyclists, motorcyclists, etc.) to travel successfully and safely.

While the invention has been described with reference to the exemplary embodiments thereof, those skilled in the art will be able to make various modifications to the described embodiments of the invention without departing from the true spirit and scope of the invention.

What is claimed is:

1. A method of providing to a wireless navigation device navigation which avoids a weather system, comprising:
obtaining current weather data relating to travel to a given destination;
defining a polygon shape around a perimeter of a weather system in said current weather data to form a weather polygon;
establishing a location of said weather polygon; and
routing a trip to said given destination which minimizes traverse of said weather polygon.

2. The method of providing to a wireless navigation device navigation which avoids a weather system according to claim 1, wherein:
said perimeter of said weather system is defined based on a configurable severity criteria within said weather system.

3. The method of providing to a wireless navigation device navigation which avoids a weather system according to claim 2, wherein said severity criteria including choices among weather elements corresponding to:
rain;
ice conditions; and
snow on ground.

4. The method of providing to a wireless navigation device navigation which avoids a weather system according to claim 1, further comprising:
predicting a direction of movement of said location of said weather polygon toward said routed trip.

5. The method of providing to a wireless navigation device navigation which avoids a weather system according to claim 1, wherein:
said location of said weather polygon is a center of said weather polygon.

6. The method of providing to a wireless navigation device navigation which avoids a weather system according to claim 1, further comprising:
weighting said location of said weather polygon toward a perimeter of said weather polygon which contains a higher density of severe weather than a density of remaining portions of said weather polygon.

7. The method of providing to a wireless navigation device navigation which avoids a weather system according to claim 1, wherein said wireless navigation device comprises:
a wireless phone.

8. The method of providing to a wireless navigation device navigation which avoids a weather system according to claim 1, further comprising:
predicting an intersection of said location of said weather polygon and any future portion of said routed trip.

9. The method of providing to a wireless navigation device navigation which avoids a weather system according to claim 1, further comprising:
predicting an intersection of a perimeter of said weather polygon and any future portion of said routed trip.

10. The method of providing to a wireless navigation device navigation which avoids a weather system according to claim 1, further comprising:
repeatedly revising a shape of said weather polygon as said wireless navigation device traverses said routed trip.

11. The method of providing to a wireless navigation device navigation which avoids a weather system according to claim 1, further comprising:
repeatedly revising a location of said weather polygon as said wireless navigation device traverses said routed trip.
